(19) United States
(12) Patent Application Publication
(10) Pub. No.: US 2021/0125108 A1
(43) Pub. Date: Apr. 29, 2021

(54) TRAINING A RANKING MODEL

(71) Applicant: Google LLC, Mountain View, CA (US)

(72) Inventors: Donald Arthur Metzler, JR., Marina del Rey, CA (US); Xuanhui Wang, Cupertino, CA (US); Marc Alexander Najork, Palo Alto, CA (US); Michael Bendersky, Sunnyvale, CA (US)

(73) Assignee: Google LLC, Mountain View, CA (US)

(21) Appl. No.: 15/333,086

(22) Filed: Oct. 24, 2016

(51) Int. Cl. G06N 99/00; G06F 17/30

(52) U.S. Cl. CPC G06N 99/005; G06F 17/30011

(57) ABSTRACT

Methods, systems, and apparatus, including computer programs encoded on a computer storage medium, for training a ranking machine learning model. In one aspect, a method includes the actions of receiving training data for a ranking machine learning model, the training data including training examples, and each training example including data identifying: a search query, result documents from a result list for the search query, and a result document that was selected by a user from the result list, receiving position data for each training example in the training data, the position data identifying a respective position of the selected result document in the result list for the search query in the training example; determining, for each training example in the training data, a respective selection bias value; and determining a respective importance value for each training example from the selection bias value for the training example, the importance value.

### BACKGROUND

This specification generally relates to training a machine learning model that ranks documents in response to search queries.

Online search engines generally rank documents in response to received search queries to present search results identifying documents that are responsive to the search query. Search engines generally present the search results in an order that is defined by the ranking. Search engines may rank the documents based on various factors and using various ranking techniques. Some search engines rank documents using a ranking machine learning model that receives features of an input document and, optionally, of the received search query and generates a ranking score for the input document.

### SUMMARY

This specification describes technologies for training a ranking machine learning model.

In general, one innovative aspect of the subject matter described in this specification can be embodied in methods that include the actions of receiving training data for a ranking machine learning model that is used to rank documents in response to received search queries, the training data including a plurality of training examples, and each training example of the plurality training examples including data identifying: a search query, result documents from a result list for the search query, and a result document that was selected by a user from the result list of result documents, receiving position data for each training example of the plurality of training examples in the training data, the position data identifying a respective position of the selected result document in the result list for the search query in the training example; determining, for each training example of the plurality of training examples in the training data, a respective selection bias value that represents a degree to which the position of the selected result document in the result list for the search query in the training example will impact the selection of the result document; and determining a respective importance value for each training example from the selection bias value for the training example, the importance value defining how important the training example is in training the ranking machine learning model. Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination. The method further includes: receiving experiment data identifying a plurality of experiment search queries and, for each experiment search query, a respective position in an experiment result list of experiment result documents for the experiment search query of an experiment result document that was selected by a user, wherein the positions of experiment result documents in the experiment result lists were randomly permuted before being presented to users. The method includes determining, for each of the plurality of positions, a respective count of selections of experiment result documents at the position by users in response to the plurality of experiment search queries in the experiment data; and determining, for each of the plurality of positions, a respective position bias value for the position for the position based on the respective count of selections for the position. The method includes assigning, for each training example of the plurality of training examples in the training data, the respective position bias value corresponding to the position of the selected result document in the result list of result documents for the training example to be the selection bias value for the training example. Wherein the experiment search queries in the plurality of experiment search queries each belong to a respective query class of a plurality of query classes, the method includes, for each of the plurality of query classes: determining, for each of the plurality of positions, a respective count of selections of experiment result documents at the position by users in response to experiment search queries belonging to the query class in the experiment data, and determining, for each of the plurality of positions, a respective class-specific position bias value for the position based on the respective count of selections for the position. The method includes obtaining data identifying a query class to which the search query for the training example belongs; assigning the class-specific position bias value for the query class to which the search query belongs and corresponding to the position of the selected result document for the training example in the result list of result documents for the training example to be the selection bias value for the training example. The method includes obtaining a respective feature vector for each experiment search query, generating training data for training a classifier that receives a respective feature vector for an input search query and outputs a respective query-specific position bias value for each of a plurality of positions for the input search query, and training the classifier on the training data. The method includes obtaining a feature vector for the search query in the training example; processing the feature vector using the trained classifier to generate a respective query-specific position bias value for each of the plurality of positions for the search query in the training example; and assigning the query-specific position bias value corresponding to the position of the selected result document for the training example in the result list of result documents for the search query to be the selection bias value for the training example. The method includes, for each experiment search query: labeling the experiment search query as a positive example for the position in the experiment result list of result documents for the experiment search query of the experiment search result that was selected by the user; and labeling the experiment search query as a negative example for other positions of the plurality of positions. The method includes training the ranking machine learning model on the training data using the respective importance values for the plurality of training examples in the training data. The method includes determining, for each training example of the plurality of training examples in the training data, a respective loss for the training example; adjusting, for each training example of the plurality of training examples in the training data, the loss for the training example based on the importance value for the training example to generate an adjusted loss; and training the machine learning model using the adjusted losses for the plurality of training examples in the training data. The method includes training the machine learning model by minimizing a sum of the adjusted losses for the plurality of the training examples in the training data.

The subject matter described in this specification can be implemented in particular embodiments so as to realize one or more of the following advantages. Conventional click-through data models have been used to estimate the relevance for individual query-document pairs in the context of web search. The conventional click-through data models typically require a large quantity of clicks for each pair of individual query and result documents and this makes the click-through data models difficult to apply in systems where click data is highly sparse due to personalized corpora and information needs, e.g., personal search. Compared to the conventional click-through data models, a system that incorporates selection bias for various result list positions when training a ranking model can more effectively leverage sparse click data while reducing or eliminating the effects of selection bias on the ranking scores generated by the trained model. Thus, the trained model can provide accurate ranking scores even when click data is highly sparse, resulting in search results that better satisfy the informational needs of users.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example search system.

FIG. 2 is a flowchart of an example process for determining a respective importance value for each training example in training data.

FIG. 3 is a flowchart of an example process for determining a respective selection bias value for each training example in training data.

FIG. 4 is a flowchart of an example process for determining a respective selection bias value for each training example in training data.

FIG. 5 is a flowchart of an example process for determining a respective selection bias value for each training example in training data.

FIG. 6 is a flowchart of an example process for training a ranking machine learning model.

Like reference numbers and designations in the various drawings indicate like elements.

### DETAILED DESCRIPTION

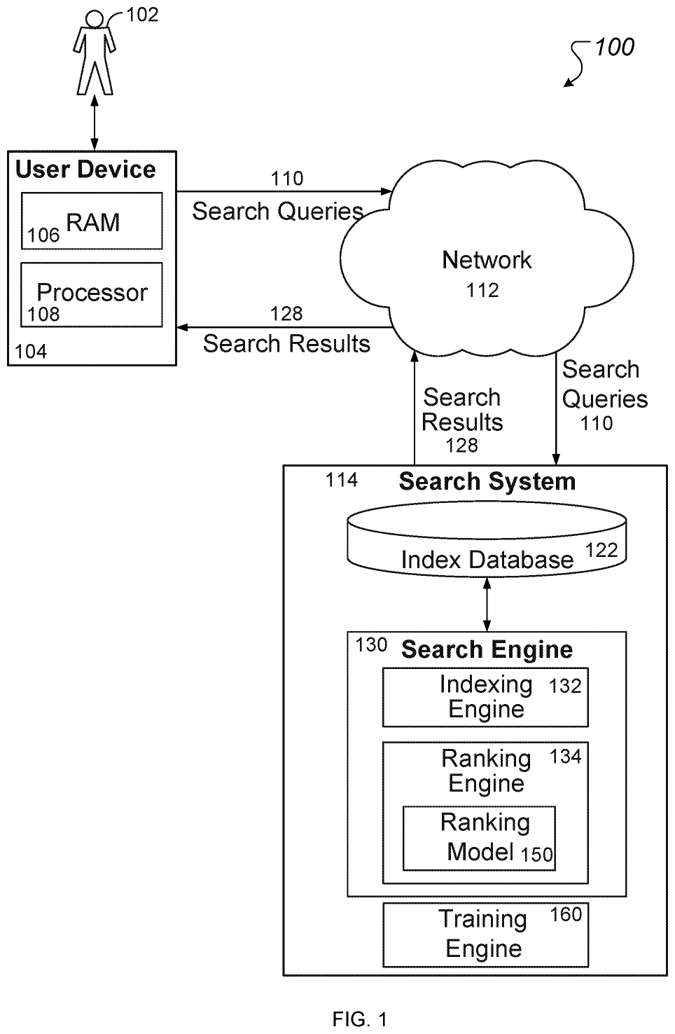

FIG. 1 shows an example search system 114. The search system 114 is an example of an information retrieval system in which the systems, components, and techniques described below can be implemented.

A user 102 can interact with the search system 114 through a user device 104. For example, the user device 104 can be a computer coupled to the search system 114 through a data communication network 112, e.g., local area network (LAN) or wide area network (WAN), e.g., the Internet, or a combination of networks. In some cases, the search system 114 can be implemented on the user device 104, for example, if a user installs an application that performs searches on the user device 104. The user device 104 will generally include a memory, e.g., a random access memory (RAM) 106, for storing instructions and data and a processor 108 for executing stored instructions. The memory can include both read only and writable memory.

Generally, the search system 114 is configured to search a specific collection of documents that are associated with the user 102 of the user device 104. In this specification, the term “document” will be used broadly to include any machine-readable and machine-storable work product. Documents may include, for example, an e-mail, a file, a combination of files, one or more files with embedded links to other files, a news group posting, a blog, a business listing, an electronic version of printed text, a web advertisement, etc.

For example, the collection of documents that the search system 114 is configured to search may be e-mails in an e-mail account of the user 102, mobile application data associated with an account of the user 102, e.g., preferences of mobile applications or usage history of mobile applications, files associated with the user 102 in a cloud document storage account, e.g., files uploaded by the user 102 or files shared with the user 102 by other users, or a different user-specific collection of documents.

The user 102 can submit search queries to the search system 114 using the user device 104. When the user 102 submits a search query 110, the search query 110 is transmitted through the network 112 to the search system 114.

When the search query 110 is received by the search system 114, a search engine 130 within the search system 114 identifies documents in the collection of documents that satisfy the search query 110 and responds to the query 110 by generating search results 128 that each identify a respective document that satisfies the search 110 and transmitted through/the network 112 to the user device 104 for presentation to the user 102, i.e., in a form that can be presented to the user 102.

The search engine 130 may include an indexing engine 132 and a ranking engine 134. The indexing engine 132 indexes documents in the collections of documents and adds the indexed documents to an index database 122. The ranking engine 134 generates respective scores for documents in the index database 122 that satisfy the search query 110 and ranks the documents based on their respective scores.

Generally, the search results 128 are displayed to the user 102 as a result list that is ordered according to the ranking scores generated by the ranking engine 132 for the documents identified by the search results 128. For example, a search result identifying a document with a higher score can be presented in a higher position in the result list than a search result identifying a document with a relatively lower score.

The ranking engine 134 generates ranking scores for documents using a ranking machine learning model 150. The ranking machine learning model 150 is a machine learning model that has been trained to receive features or other data characterizing an input document and, optionally, data characterizing the search query 110 and to generate a ranking score for the input document. The ranking machine learning model 150 can be any of a variety of machine learning models. For example, the ranking machine learning model 150 can be a deep machine learning model, e.g., a neural network, that includes multiple layers of non-linear operations. As another example, the ranking machine learning model 150 can be a shallow machine learning model, e.g., a generalized linear model.

Depending on how the ranking machine learning model 150 has been trained, the ranking score may be a prediction of the relevance of the input document to the search query 110 or may take into account both the relevance of the input document and the query-independent quality of the input document. In some implementations, the ranking engine 134 modifies the ranking scores generated by the ranking machine learning model 150 based on other factors and ranks documents using the modified ranking scores.

To train the ranking machine learning model 150 so that the model can be used in ranking document in response to received search queries, the search system also includes a training engine 160. The training engine 160 trains the ranking machine learning model 150 on training data that includes multiple training examples. Each training example identifies (i) a search query, (ii) result documents from the result list for the search query, and (iii) a result document that was selected by a user from the result list of result documents for the search query. As described in this specification, a selection of a result document in response to a search query is a selection of a search result identifying the result document from a result list of search results presented in response to the submission of the search query by a user and the documents from the result list are the documents that are identified by the search results in the result list. In order to improve the quality of the ranking scores generated by the ranking machine learning model 150 once trained, the training engine 160 trains the ranking machine learning model 150 in a manner that accounts for the position in the result list of the search result that was selected by the user. In particular, the training engine 160 determines a respective importance value for each training example based on the position in the result list of the search result that was selected by the user in response to the search query in the training example. By training the machine learning model 150 in this manner, the training engine 160 reduces or eliminates the impact of position bias on ranking scores generated by the ranking machine learning model 150 once the model has been trained.

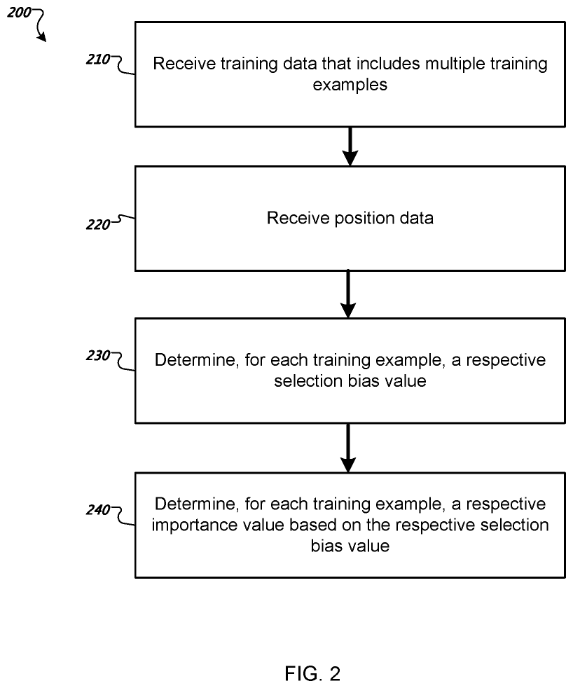

FIG. 2 is a flowchart of an example process 200 for determining a respective importance value for each training example in training data. For convenience, the process 200 will be described as being performed by a system of one or more computers located in one or more locations. For example, a search system, e.g., the search system 114 of FIG. 1, appropriately programmed in accordance with this specification, can perform the process 200.

The system receives 210 training data. The training data includes multiple training examples.

The system receives 220 position data. The position data identifies, for each training example in the training data, a respective position in the result list for the search query in the training example of the result document that was selected by the user in response to the search query, i.e., of the position of the search result that was selected by the user from the result list generated in response to the search query.

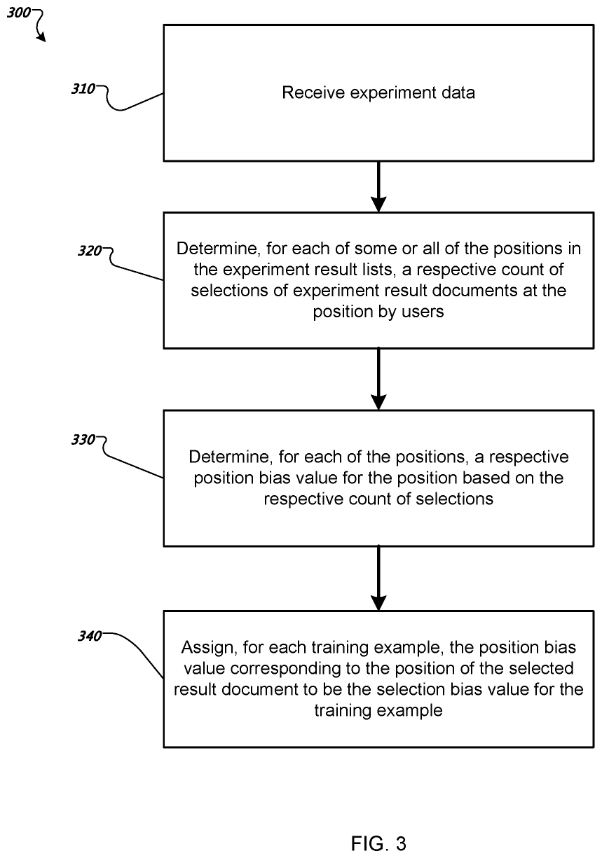

The system determines 230, for each training example in the training data, a respective selection bias value. The selection bias value represents a degree to which the position of the selected result document in the result list for the search query in the training example impacted the selection of the result document. The selection bias value can be determined using various techniques. Example processes for determining a selection bias value for a training example are described in below with reference to FIGS. 3-5.

The system determines 240, for each training example in the training data, a respective importance value. The importance value for a given training example defines how important the training example is in training the ranking machine learning model. The respective importance value for each training example in the training data can be determined based on the respective selection bias value for the training example. For example, the importance value for a particular training example can be the inverse of the selection bias value for the training example or, more generally, be inversely proportional to the selection bias value for the training example.

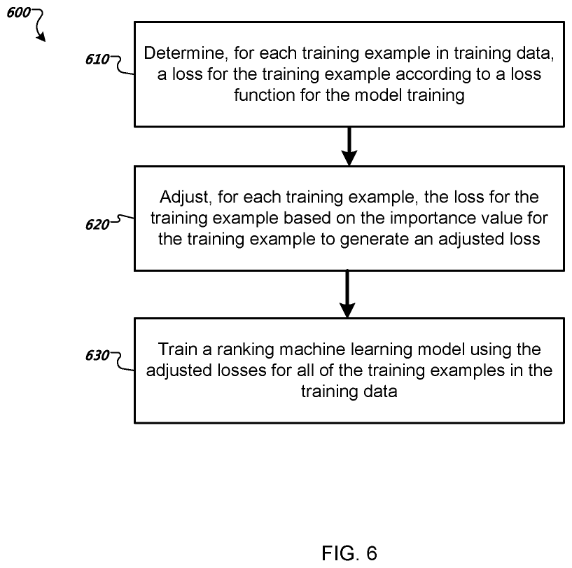

Once the system determines the respective importance values for the training samples in the training data, the system trains the ranking machine learning model on the training data using the importance values. An example process for training a ranking machine learning model using importance values is described in below with reference to FIG. 6.

FIG. 3 is a flowchart of an example process 300 for determining a respective selection bias value for each training example in training data. For convenience, the process 300 will be described as being performed by a system of one or more computers located in one or more locations. For example, a search system, e.g., the search system 114 of FIG. 1, appropriately programmed in accordance with this specification, can perform the process 300.

The system receives 310 experiment data identifying experiment search queries and, for each experiment search query, a respective position in an experiment result list of experiment result documents for the experiment search query of an experiment result document that was selected by a user. The positions of experiment result documents in the experiment result lists were randomly permuted before the experiment result lists were presented to users. Thus, the experiment result document that was selected by the user from a given result list was equally likely to be assigned to any of the positions in the experiment result list.

The system determines 320, for each of some or all of the positions in the experiment result lists, a respective count of selections of experiment result documents at the position by users in response to the experiment search queries in the experiment data. For example, the system can determine a respective count of selections for the top N positions in experiment result lists, where N is an integer greater than 1, e.g., four, five, or ten, or for each position in the experiment result lists. As an example, where the system receives experiment data including 10 experiment result lists, if users selected a first position for 7 of the experiment result lists, a second position for 2 of the experiment result lists, and a third position for 1 of the experiment result lists, the count of selections for the first position can be 7, the count of selections for the second position can be 2, and the count of selections for the third position can be 1.

The system determines 330, for each of the positions, a respective position bias value for the position based on the respective count of selections for the position. The position bias value represents a degree to which the position of the selected experiment result document in the experiment result list for the experiment search query in the experiment data impacted the selection of the experiment result document. In some implementations, a respective position bias value for each position can be proportional to a respective count of selections for the position. In some implementations, a respective position bias value for each position can be computed by dividing the count of selections at the position by the count of selections at any position of the positions in the experiment result lists.

The system assigns 340, for each training example in the training data, the position bias value corresponding to the position of the selected result document in the result list of result documents for the training example to be the selection bias value for the training example.

For example, where the system determines a position bias value b₁ for a first position using the count of selections of experiment result documents at the first position, if the first position is the position of a result document that the user selected in the result list for the training example in the training data, the system determines that the position bias value b₁ is the selection bias value for the training example.

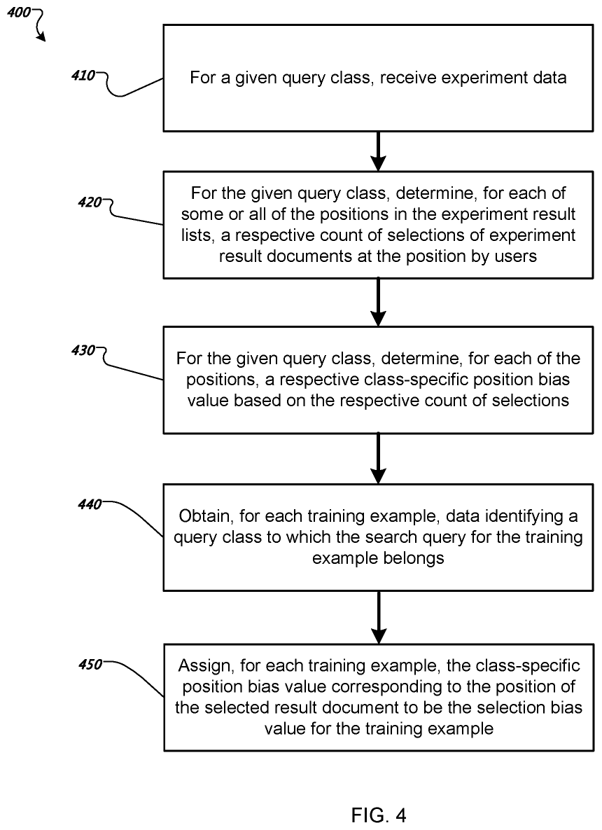

FIG. 4 is a flowchart of an example process 400 for determining a respective selection bias value for each training example in training data. For convenience, the process 400 will be described as being performed by a system of one or more computers located in one or more locations. For example, a search system, e.g., the search system 114 of FIG. 1, appropriately programmed in accordance with this specification, can perform the process 400.

In this example, each experiment search query in experiment search queries has been classified as belonging to a respective query class of a predetermined set of query classes. The system performs the process 400 for each class in the predetermined set of query classes.

For a given query class, the system receives 410 experiment data identifying experiment search queries that were classified as belonging to the given query class and, for each of these experiment search queries, a respective position in an experiment result list of result documents for the experiment search query of an experiment result document that was selected by a user.

For the given query class, the system determines 420, for each of some or all of the positions in the experiment result lists, a respective count of selections of experiment result documents at the position by users in response to the experiment search queries belonging to the query class in the experiment data. For example, the system can determine a respective count of selections for the top N positions in the experiment result lists.

For the given query class, the system determines 430, for each of the positions, a respective class-specific position bias value for the position based on the respective count of selections for the position. In some implementations, a respective position bias value for each position can be proportional to a respective count of selections for the position.

The system obtains 440 data identifying, for each training example in the training data, a query class to which the search query for the training example belongs.

The system assigns 450, for each training example in the training data, the class-specific position bias value for the query class to which the search query belongs and corresponding to the position of the selected result document in the result list of result documents for the training example to be the selection bias value for the training example.

For example, where a search query Q belongs to a query class t and the system determines a class-specific position bias value bᵢ^{t} for a first position using the count of selections of experiment result documents at the first position, if the first position is the position of a result document that the user selected in the result list for the training example in the training data, the system determines that the class-specific position bias value b₁^{t} is the selection bias value for the training example.

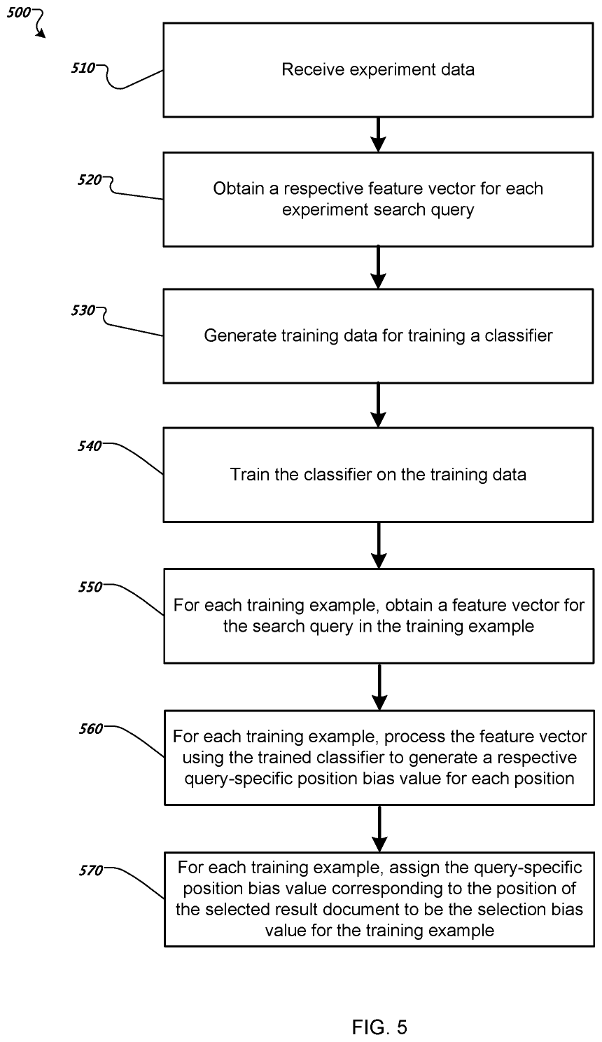

FIG. 5 is a flowchart of an example process 500 for determining a respective selection bias value for each training example in training data. For convenience, the process 500 will be described as being performed by a system of one or more computers located in one or more locations. For example, a search system, e.g., the search system 114 of FIG. 1, appropriately programmed in accordance with this specification, can perform the process 500.

The system receives 510 experiment data identifying experiment search queries and, for each experiment search query, a respective position in an experiment result list of result documents for the experiment search query of an experiment result document that was selected by a user.

The system obtains 520 a respective feature vector for each experiment search query of the experiment search queries. The feature vectors can be query-specific or user-specific. For example, the query features may include the number of words in the query, the class of the query, or the preferred language of the user.

The system generates 530 training data for training a classifier. The classifier is trained to receive a respective feature vector for an input search query and output a respective query-specific position bias value for each of positions for the input search query.

The training data can include positive examples of experiment search queries and negative examples of experiment search queries. For example, the system can label an experiment search query as a positive example for the position in the experiment result list of result documents for the experiment search query of the experiment search result that was selected by the user. The system can label the experiment search query as a negative example for non-selected positions of the positions in the experiment result list of result documents.

The system trains 540 the classifier on the training data. Training the classifier can be a machine learning process that learns respective weights to apply to each input feature vector. In particular, a classifier is trained using a conventional iterative machine learning training process that determines trained weights for each result list position. Based on initial weights assigned to each result list position, the iterative process attempts to find optimal weights. For example, the query-specific position bias value bᵢ^{Q} for a given position i for a given search query Q can be given using the following formula:

$${b}_{i}^{Q} = \frac{1}{1 + exp ( {β}_{i} \cdot v ( Q )} ) ,$$

where, βᵢ denotes the trained weights for position i, and v(Q) denotes a feature vector for the search query Q.

In some implementations, the classifier is a logistic regression model. In other implementations, other suitable classifiers can be used including naïve Bayes, decisions trees, maximum entropy, neural networks, or support vector machine based classifiers.

For each training example in the training data, the system obtains 550 a feature vector for the search query in the training example.

For each training example in the training data, the system processes 560 the feature vector using the trained classifier to generate a respective query-specific position bias value for each of the positions for the search query in the training example. The trained classifier receives the feature vector as input and outputs a respective query-specific position bias value for each of positions in the result list for the search query in the training example.

For each training example in the training data, the system assigns 570 the query-specific position bias value corresponding to the position of the selected result document for the training example in the result list of result documents for the search query to be the selection bias value for the training example.

For example, where the system determines a query-specific position bias value b₁^{Q} for a first position using the trained classifier, if the first position is the position of a result document that the user selected in the result list for the training example in the training data, the system determines that the query-specific position bias value b₁^{Q} is the selection bias value for the training example.

FIG. 6 is a flowchart of an example process 600 for training a ranking machine learning model. For convenience, the process 600 will be described as being performed by a system of one or more computers located in one or more locations. For example, a search system, e.g., the search system 114 of FIG. 1, appropriately programmed in accordance with this specification, can perform the process 600.

The system can perform the process 600 for each training example in the training data to train the ranking machine learning model, i.e., to determine trained values of the parameters of the ranking machine learning model from initial values of the parameters.

The system determines 610, for each training example in the training data, a loss for the training example according to a loss function being used to train the model. The system can use any of a variety of loss functions for the model training. For example, the system can use a pair-wise loss function or a result list-wise loss function. For example, one pair-wise loss l(Q, f) may satisfy:

$$l ( Q , f ) = {\sum }_{{x}_{i} ≻ {Qx}_{j}} {max ( 0 , f ( {x}_{j} ) - f ( {x}_{i} ) )}^{2} ,$$

where Q=(q,{x₁, . . . , xₙ}) denotes a query string q and a set of result documents {x₁, . . . , xₙ} for the query string q, f(x) is the ranking score generated by the ranking machine learning model for a result document x, and xᵢ>Qxⱼ denote all pairs xᵢ, xⱼ of result documents in Q for which xᵢ denotes a result document that was selected for the search query and xⱼ denotes non-selected result documents in Q.

The system adjusts 620, for each training example in the training data, the loss for the training example based on the importance value for the training example to generate an adjusted loss. For example, the adjusted loss L(f) for a particular training example may satisfy:

L(f)=w·l(Q,f),

where w denotes the importance value for the particular training example.

The system trains 630 the ranking machine learning model using adjusted losses for all of the training examples in the training data. In some implementations, the system trains the ranking machine learning model to minimize the sum of the adjusted losses of all of the training examples in the training data. For example, the sum of the adjusted losses Lₛ(f) may satisfy:

$${L}_{s} ( f ) = {\sum }_{Q ∈ S} {w}_{Q} \cdot l ( Q , f )$$

where S denotes the training examples in the training data and w_{Q} denotes importance value for each training example in the training data.

In some implementations, the system trains the ranking machine learning model to minimize the average of the adjusted losses for all of the training examples in the training data. For example, the average of the adjusted losses La(f) may satisfy:

$${L}_{a} ( f ) = \frac{1}{\vert S \vert} {\sum }_{Q ∈ S} {w}_{Q} \cdot l ( Q , f )$$

The system can use any appropriate machine learning technique to train the machine learning model to reduce the loss for the training example. For example, the system can use a Multiple Additive Regression Trees (MART) learning algorithm or another conventional gradient-based learning algorithm to train the model.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification, the term “database” will be used broadly to refer to any collection of data: the data does not need to be structured in any particular way, or structured at all, and it can be stored on storage devices in one or more locations. Thus, for example, an index database can include multiple collections of data, each of which may be organized and accessed differently.

Similarly, in this specification the term “engine” will be used broadly to refer to a software based system or subsystem that can perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

Control of the various systems described in this specification, or portions of them, can be implemented in a computer program product that includes instructions that are stored on one or more non-transitory machine-readable storage media, and that are executable on one or more processing devices. The systems described in this specification, or portions of them, can each be implemented as an apparatus, method, or electronic system that may include one or more processing devices and memory to store executable instructions to perform the operations described in this specification.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
receiving training data for a ranking machine learning model that is used to rank documents in response to received search queries, the training data including a plurality of training examples, and each training example of the plurality training examples including data identifying:
a search query,
result documents from a result list for the search query, and
a result document that was selected by a user from the result list of result documents,
receiving position data for each training example of the plurality of training examples in the training data, the position data identifying a respective position of the selected result document in the result list for the search query in the training example;
determining, for each training example of the plurality of training examples in the training data, a respective selection bias value that represents a degree to which the position of the selected result document in the result list for the search query in the training example will impact the selection of the result document;
determining, for each training example of the plurality of training examples in the training data and from the respective selection bias value for the training example, a respective importance value that is inversely proportional to the respective selection bias value for the training example; and
training the ranking machine learning model on the training data, the training comprising, for each training example:
determining a loss for the training example that is based on (i) ranking scores generated by the ranking machine learning model for result documents in the result list that is identified in the training example and (ii) the result document that is identified in the training example as the result document that was selected by the user from the result list that is identified in the training example;
generating an adjusted loss for the training example by adjusting the loss for the training example using the respective importance value for the training example that is inversely proportional to the respective selection bias value for the training example, wherein the adjusted loss for weights losses for training examples having higher respective importance values more strongly than losses having relatively lower respective importance values in the training of the ranking machine learning model wherein the adjusted loss L(f) satisfies:
L(f)=w·l(Q,f),
wherein w denotes the importance value for the training example that is inversely proportional to the respective selection bias value for the training example, and l(Q, f) denotes the loss for the training example; and
training the ranking machine learning model on the adjusted loss.

2. The method of claim 1, further comprising:
receiving experiment data identifying a plurality of experiment search queries and, for each experiment search query, a respective position in an experiment result list of experiment result documents for the experiment search query of an experiment result document that was selected by a user, wherein the positions of experiment result documents in the experiment result lists were randomly permuted before being presented to users.

3. The method of claim 2, further comprising:
determining, for each of the plurality of positions, a respective count of selections of experiment result documents at the position by users in response to the plurality of experiment search queries in the experiment data; and
determining, for each of the plurality of positions, a respective position bias value for the position based on the respective count of selections for the position.

4. The method of claim 3, wherein determining, for each training example of the plurality of training examples in the training data, a respective selection bias value comprises:
assigning, for each training example of the plurality of training examples in the training data, the respective position bias value corresponding to the position of the selected result document in the result list of result documents for the training example to be the selection bias value for the training example.

5. The method of claim 2, wherein the experiment search queries in the plurality of experiment search queries each belong to a respective query class of a plurality of query classes, and wherein the method further comprises, for each of the plurality of query classes:
determining, for each of the plurality of positions, a respective count of selections of experiment result documents at the position by users in response to experiment search queries belonging to the query class in the experiment data, and
determining, for each of the plurality of positions, a respective class-specific position bias value for the position based on the respective count of selections for the position.

6. The method of claim 5, wherein determining, for each training example of the plurality of training examples in the training data, a respective selection bias value comprises:
obtaining data identifying a query class to which the search query for the training example belongs;
assigning the class-specific position bias value for the query class to which the search query belongs and corresponding to the position of the selected result document for the training example in the result list of result documents for the training example to be the selection bias value for the training example.

7. The method of claim 2, further comprising:
obtaining a respective feature vector for each experiment search query,
generating training data for training a classifier that receives a respective feature vector for an input search query and outputs a respective query-specific position bias value for each of a plurality of positions for the input search query, and
training the classifier on the training data.

8. The method of claim 7, wherein determining, for each training example of the plurality of training examples in the training data, a respective selection bias value comprises:
obtaining a feature vector for the search query in the training example;
processing the feature vector using the trained classifier to generate a respective query-specific position bias value for each of the plurality of positions for the search query in the training example; and
assigning the query-specific position bias value corresponding to the position of the selected result document for the training example in the result list of result documents for the search query to be the selection bias value for the training example.

9. The method of claim 7, wherein generating training data for training a classifier that receives a respective feature vector for an input search query and outputs a respective query-specific position bias value for each of a plurality of positions for the input search query comprises:
for each experiment search query:
labeling the experiment search query as a positive example for the position in the experiment result list of result documents for the experiment search query of the experiment search result that was selected by the user; and
labeling the experiment search query as a negative example for other positions of the plurality of positions.

10. (canceled)

11. (canceled)

12. The method of claim 1, wherein training the machine learning model using the adjusted losses for the plurality of training examples in the training data comprises:
training the machine learning model by minimizing a sum of the adjusted losses for the plurality of the training examples in the training data.

13. A system comprising one or more computers and one or more storage devices storing instructions that, when executed by one or more computers, cause the one or more computers to perform operations comprising:
receiving training data for a ranking machine learning model that is used to rank documents in response to received search queries, the training data including a plurality of training examples, and each training example of the plurality training examples including data identifying:
a search query,
result documents from a result list for the search query, and
a result document that was selected by a user from the result list of result documents,
receiving position data for each training example of the plurality of training examples in the training data, the position data identifying a respective position of the selected result document in the result list for the search query in the training example;
determining, for each training example of the plurality of training examples in the training data, a respective selection bias value that represents a degree to which the position of the selected result document in the result list for the search query in the training example will impact the selection of the result document;
determining, for each training example of the plurality of training examples in the training data and from the respective selection bias value for the training example, a respective importance value that is inversely proportional to the respective selection bias value for the training example; and
training the ranking machine learning model on the training data, the training comprising, for each training example:
determining a loss for the training example that is based on (i) ranking scores generated by the ranking machine learning model for result documents in the result list that is identified in the training example and (ii) the result document that is identified in the training example as the result document that was selected by the user from the result list that is identified in the training example;
generating an adjusted loss for the training example by adjusting the loss for the training example using the respective importance value for the training example that is inversely proportional to the respective selection bias value for the training example, wherein the adjusted loss for weights losses for training examples having higher respective importance values more strongly than losses having relatively lower respective importance values in the training of the ranking machine learning model wherein the adjusted loss L(f) satisfies:
L(f)=w·l(Q,f),
wherein w denotes the importance value for the training example that is inversely proportional to the respective selection bias value for the training example, and l(Q, f) denotes the loss for the training example; and
training the ranking machine learning model on the adjusted loss.

14. The system of claim 13, the operations further comprising:
receiving experiment data identifying a plurality of experiment search queries and, for each experiment search query, a respective position in an experiment result list of experiment result documents for the experiment search query of an experiment result document that was selected by a user, wherein the positions of experiment result documents in the experiment result lists were randomly permuted before being presented to users.

15. The system of claim 14, the operations further comprising:
determining, for each of the plurality of positions, a respective count of selections of experiment result documents at the position by users in response to the plurality of experiment search queries in the experiment data; and
determining, for each of the plurality of positions, a respective position bias value for the position based on the respective count of selections for the position.

16. The system of claim 15, wherein determining, for each training example of the plurality of training examples in the training data, a respective selection bias value comprises:
assigning, for each training example of the plurality of training examples in the training data, the respective position bias value corresponding to the position of the selected result document in the result list of result documents for the training example to be the selection bias value for the training example.

17. The system of claim 14, wherein the experiment search queries in the plurality of experiment search queries each belong to a respective query class of a plurality of query classes, and wherein the method further comprises, for each of the plurality of query classes:
determining, for each of the plurality of positions, a respective count of selections of experiment result documents at the position by users in response to experiment search queries belonging to the query class in the experiment data, and
determining, for each of the plurality of positions, a respective class-specific position bias value for the position based on the respective count of selections for the position.

18. The system of claim 17, wherein determining, for each training example of the plurality of training examples in the training data, a respective selection bias value comprises:
obtaining data identifying a query class to which the search query for the training example belongs;
assigning the class-specific position bias value for the query class to which the search query belongs and corresponding to the position of the selected result document for the training example in the result list of result documents for the training example to be the selection bias value for the training example.

19. The system of claim 14, the operations further comprising:
obtaining a respective feature vector for each experiment search query,
generating training data for training a classifier that receives a respective feature vector for an input search query and outputs a respective query-specific position bias value for each of a plurality of positions for the input search query, and
training the classifier on the training data.

20. The system of claim 19, wherein determining, for each training example of the plurality of training examples in the training data, a respective selection bias value comprises:
obtaining a feature vector for the search query in the training example;
processing the feature vector using the trained classifier to generate a respective query-specific position bias value for each of the plurality of positions for the search query in the training example; and
assigning the query-specific position bias value corresponding to the position of the selected result document for the training example in the result list of result documents for the search query to be the selection bias value for the training example.

21. (canceled)

22. One or more non-transitory computer-readable storage media storing instructions that when executed by one or more computers cause the one or more computers to perform operations comprising:
receiving training data for a ranking machine learning model that is used to rank documents in response to received search queries, the training data including a plurality of training examples, and each training example of the plurality training examples including data identifying:
a search query,
result documents from a result list for the search query, and
a result document that was selected by a user from the result list of result documents,
receiving position data for each training example of the plurality of training examples in the training data, the position data identifying a respective position of the selected result document in the result list for the search query in the training example;
determining, for each training example of the plurality of training examples in the training data, a respective selection bias value that represents a degree to which the position of the selected result document in the result list for the search query in the training example will impact the selection of the result document;
determining, for each training example of the plurality of training examples in the training data and from the respective selection bias value for the training example, a respective importance value that is inversely proportional to the respective selection bias value for the training example; and
training the ranking machine learning model on the training data, the training comprising, for each training example:
determining a loss for the training example that is based on (i) ranking scores generated by the ranking machine learning model for result documents in the result list that is identified in the training example and (ii) the result document that is identified in the training example as the result document that was selected by the user from the result list that is identified in the training example;
generating an adjusted loss for the training example by adjusting the loss for the training example using the respective importance value for the training example that is inversely proportional to the respective selection bias value for the training example, wherein the adjusted loss for weights losses for training examples having higher respective importance values more strongly than losses having relatively lower respective importance values in the training of the ranking machine learning model wherein the adjusted loss L(f) satisfies:
L(f)=w·l(Q,f),
wherein w denotes the importance value for the training example that is inversely proportional to the respective selection bias value for the training example, and l(Q, f) denotes the loss for the training example; and
training the ranking machine learning model on the adjusted loss.

23. The computer-readable storage media of claim 22, wherein determining, for each training example of the plurality of training examples in the training data, a respective selection bias value comprises:
obtaining a feature vector for the search query in the training example;
processing the feature vector using the trained classifier to generate a respective query-specific position bias value for each of the plurality of positions for the search query in the training example; and
assigning the query-specific position bias value corresponding to the position of the selected result document for the training example in the result list of result documents for the search query to be the selection bias value for the training example.
